(19) United States
(12) Patent Application Publication
(10) Pub. No.: US 2008/0170402 A1
(43) Pub. Date: Jul. 17, 2008

(54) DIRECT TYPE BACKLIGHT MODULE

(75) Inventors: Chao-Shih Yen, Taitung City (TW); Cheng-Yi Chen, Keelung City (TW)

Correspondence Address: BACON & THOMAS, PLLC, 625 SLATERS LANE, FOURTH FLOOR, ALEXANDRIA, VA, 22314, US

(73) Assignee: Forward Electronics Co., Ltd., Taipei City (TW)

(21) Appl. No.: 12/014,967

(22) Filed: Jan. 16, 2008

(30) Foreign Application Priority Data
Jan. 17, 2007 (TW) 096101757

(51) Int. Cl. F21V 7/00

(52) U.S. Cl. 362/297

(57) ABSTRACT

A direct type backlight module with ultra-thin diffuser and excellent brightness uniformity is disclosed to include a housing, a reflector, a first diffuser, light sources, and support members, in which the reflector is mounted on the bottom panel of the housing, the first diffuser is mounted on the opening of the housing and having a visible light (400˜800 nm) transmission not greater than 75%, and the visible light (400˜800 nm) transmission of the top part of each support member is within 5%˜85%.

### BACKGROUND OF THE INVENTION

1. Field of the Invention

The present invention relates to a direct type backlight module and more particularly, to a direct type backlight module that is specifically designed to be used in a LCD monitor.

2. Description of Related Art

For the advantages of light, thin, and space-saving characteristics, LCD monitor is becoming the mainstream of the market to replace conventional CRT monitors. Because a LCD monitor is not a self-illumination monitor, it needs to use a backlight module as a light source of the monitor. Following the development of large size LCD display panels and critical requirements on picture quality such as brightness, contrast and color tone, the conventional side light type backlight modules cannot meet these requirements. Therefore, the direct type backlight modules have become the mainstream of the high quality LCD monitors or LCD TVs

A direct type backlight module comprises CCFLs (light source), diffuser, reflector, and housing. The CCFLs (light source) that provide the monitor with the necessary light source is disposed at the bottom side of the LCD monitor. However, CCFLs are linear light sources arranged in the backlight module at a regular or irregular pitch. Therefore, a diffuser is disposed above the CCFLs and it is to effectively convert light rays from the CCFLs into a uniformity planar light source. A reflector is disposed beneath the CCFLs to reflect light rays upwards, enabling light rays from the CCFLs to be fully utilized to enhance the brightness.

Conventionally, in a large size direct type backlight module, a thick diffuser is used to support the top optical film(s) and to prevent falling of the optical film(s) due to the effect of its (there) gravity. Therefore, the thickness of the diffusers of conventional backlight modules usually ranges from 1.5 to 3 mm. Further, multiple support members are usually used in a backlight module to support the diffuser. The existent support member affects the original optical path, and then it causes a sharp brightness around the contact area between each support member and the diffuser. The aforesaid conventional design requires a thick diffuser and may cause an uneven brightness problem. It not only increases the total weight of the backlight module but also wastes much diffuser material. Therefore, this conventional design is neither economic nor environmental protective.

### SUMMARY OF THE INVENTION

The present invention has been accomplished under the circumstances in view. It is the main object of the present invention to provide a direct type backlight module, which improves the brightness uniformity. It is another object of the present invention to provide a direct type backlight module with an ultra-thin diffuser, which saves much the diffuser material, thereby greatly reducing the weight of the backlight module.

To achieve these and other objects of the present invention, the direct type backlight module includes housing, reflector, diffuser, support members and light source. The housing comprises a bottom plane and a plurality of sidewalls, and the bottom panel and the sidewalls comprise a space and the top surface is opening. A reflector sets on the bottom panel in the inside space. A first diffuser sets on the sidewalls and to cover the top surface, and has a visible light transmission not greater than 75%; at least one light source mounted in the inside space. A plurality of support members in the inside space to support the first diffuser and the each of them has a top part to support the first diffuser. The top part has a visible light transmission within 5%˜85%.

Further, the first diffuser has a thickness within 0.05 mm˜0.6 mm. The contact area between the top part of each support member and the first diffuser is not larger than 1 mm². The top part of the support member can be any shape, such as a circular, oval, rectangular and polygonal shape. Therefore, the contact area between the top part of each support member and the first diffuser can be a circular, oval, rectangular, or polygonal shape.

There is no particular limitation to the material for the first diffuser. The material for the first diffuser can be polyethylene terephthalate, polycarbonate, polystyrene, methyl methacrylate, styrene, polyethylene, styrene acrylonitile, polypropylene, or polyvinyl chloride.

There is no particular, limitation to the material for the support members. The material for the support members can be polycarbonate, polystyrene, methyl methacrylate, styrene-methyl methacrylate, styrene, polyethylene, styrene acrylonitrile, polypropylene, or polyvinyl chloride.

Further, the at least one light source each can be a CCFL (cold cathode fluorescent lamp), HCFL, (hot cathode fluorescent lamp), or LED (light emitting diode).

Further, there is no particular limitation to the fixation of the support members in the direct type backlight module. Preferably, the support members comprise a retaining ring to fasten the at least one light source. Alternatively, the support members can be directly affixed to the reflector.

Further, there is no particular limitation to the fixation of the reflector in the direct type backlight module. The reflector can be adhered to the bottom panel or formed integral with the housing.

The direct type backlight module further comprises a light enhancement film, a polarized light enhancement film, and a second diffuser respectively disposed above the first diffuser.

### BRIEF DESCRIPTION OF THE DRAWINGS

FIG. 1 is an exploded view of a direct type backlight module in accordance with a first embodiment of the present invention.

FIG. 2 is schematic sectional view of the direct type backlight module according to the first embodiment of the present invention.

FIG. 3 is an enlarged view of a part of the direct type backlight module according to the first embodiment of the present invention.

FIG. 4 is an enlarged view of a part of a direct type backlight module in accordance with a third embodiment of the present invention.

### DETAILED DESCRIPTION OF THE PREFERRED EMBODIMENTS

### Embodiment 1

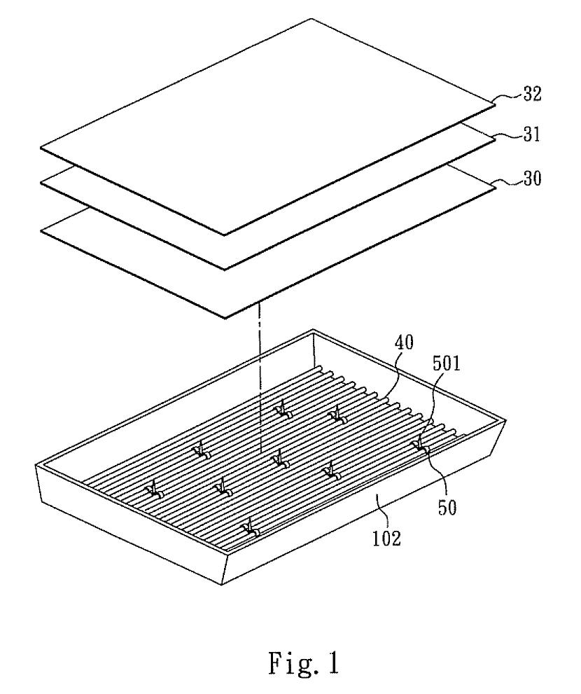

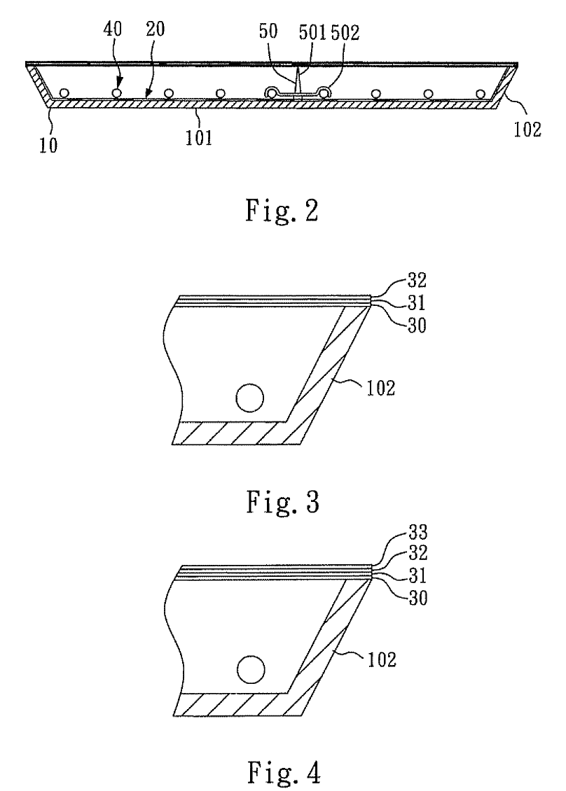

Referring to FIGS. 1 and 2, a direct type backlight module according to this embodiment is designed for using to a 32″ LCD monitor. The direct type backlight module comprises a housing 10, which is comprised of a bottom panel 101 and four sidewalls 102 extending around the bottom panel 101 and defining with the bottom panel 101 an inside space having an opening, a reflector 20 mounted on the top surface of the bottom panel 101 inside the housing 10, a first diffuser 30 mounted on the opening of the inside space of the housing 10 to close inside space, 16 pcs of CCFLs (Cold Cathode Fluorescent Lamps) 40 arranged in the enclosed space inside the housing 10, 16 pcs of support members 50 (not all shown) mounted in the enclosed space inside the housing 10, a brightness enhancement film 31 arranged oil the top side of the first diffuser 30, and a polarized brightness enhancement film 32 arranged on the top side of the prism lens 31 (see FIG. 3). The support members 50 each have a top part 501 that supports the first diffuser 30.

In a LCD monitor, a backlight module provides the necessary light source. Therefore, the optical characteristics of the backlight module of a LCD monitor are one of the important factors that determine the image quality of the LCD monitor. Except brightness, the most important thing to be considered when designing a direct type backlight module is to provide an excellent uniformity of the planar light source. In this regard, there are two common problems must be overcome. One of the problems is the uneven brightness due to the location arrangement of the CCFLs 40. The other problem is the uneven brightness resulted from contact area between the support members 50 and the first diffuser 30. The technical features of the present invention are discussed as follows.

The CCFLs 40 provide the necessary light source for the LCD monitor. Because these CCFLs 40 are linear light sources and kept apart from one another in the backlight module, the top-sided first diffuser 30 is necessary to effectively convert light rays from the CCFLs 40 into a uniform planar light source.

On the other hand, the reflector 20, which is disposed beneath the CCFLs 40, reflects light rays from the CCFLs 40 toward the top side, and effectively enhances the brightness of the light of the CCFLs 40.

According to this embodiment, there is a brightness enhancement film 31 and a polarized brightness enhancement film 32 arranged over the first diffuser 30. The brightness enhancement film 31 has a prism-like microstructure on the surface adapted to deflect light through a big angle so as to gather light passed therethrough in direction perpendicular to the brightness enhancement film 31, thereby enhancing the brightness. The polarized brightness enhancement film 32 admits light with one particular polarization pass and reflects the other differently polarized light. The reflector 20 further reflects the light that is reflected by the polarized brightness enhancement film 32, and thereby changes its polarization for enabling the polarized light to fall upon the polarized brightness enhancement film 32. Therefore, light rays that pass through the polarized brightness enhancement film 32 have a certain degree of polarization. These light rays have a high transmittancy for passing through the lower polarizer in the LCD monitor to enhance the brightness.

According to this embodiment, the first diffuser 30 is prepared from PET (polyethylene terephthalate), and it has a thickness about 0.2 mm. To avoid uneven brightness due to the location arrangement of the CCFLs 40, the visible light transmission of die first diffuser 30 is designed to be 56%.

The support members 50 each have two outwardly extending retaining rings 502 that are fastened the CCFLs 40 to secure the support member 50 in place and also to enhance shock resistance of the associating CCFLs 40. The support members 50 have the respective bottom part to keep in contact with the reflector 20. The top part 501 of each support member 50 is a cone having a circular contact surface that supports the first diffuser 30. This circular contact surface has an area about 0.785 mm². These material of the support members 50 is the PC (polycarbonate). The visible light transmission of the top part 501 of each support member 50 is 68.1%.

We measured the brightness of 25 different positions of the backlight module after the backlight module was turned on, and then calculated the brightness uniformity subject to the following equation 1 to obtain the result of 83.5%. During this measurement, we didn't see any bright spot or dark spot at the contact surface between the top part 501 of each support member and the diffuser 30.

U=[1−(Max−Min)/(Max+Min)]×100% Equation 1

In which, U is the uniformity, Max is the maximum brightness value, and Min is the minimum brightness value.

In this embodiment, it is very important to match the characteristics of the visible light transmission of the first diffuser 50 and the visible light transmission of the top part 501 of each support member. If both the characteristics are not match, a bright spot or dark spot will appear at the contact area. Further, the visible light transmission of the first diffuser 30 must be in a predetermined range to prevent the uneven brightness due to the position of the CCFLs. In the following Comparative Examples, the importance of the visible light transmission of the first diffuser 30 and the visible light transmission of the top part 501 of each support member will be more apparently understood.

### Comparative Example I

This comparative example is simply to change the visible light transmission of the top part 501 of each support member 50 of the direct type backlight module to 89.4% while the other conditions are same as the previous Preferred Embodiment I. This comparative example is to use the same first diffuser 30 (having a thickness about 0.2 mm and visible light transmission 56%). The result of this combination shows the visible bright spots at the contact area between the top part 501 of each support member and the first diffuser 30. It is because the excessively high visible light transmission of the top part 501 of each support member. The top part 501 of each support member like a convex lens to have light collection effect, and it makes the sharp brightness on the contact surface.

### Comparative Example II

This comparative example is to use an opaque material with a white surface as the support members 50 while the other conditions are same as the aforesaid Preferred Embodiment I. This comparative example is also to use the same first diffuser 30 (having a thickness about 0.2 mm and visible light transmission 56%). Therefore, the visible light transmission of the top part 501 of each support member is about 0%. The result of this combination shows a severe visible dark spot at the contact area between the top part 501 of each support member and the first diffuser 30.

### Comparative Example III

The direct type backlight module of this comparative example is simply to change the thickness of the first diffuser 30 to 0.1 mm and to raise the visible light transmission to 78.5% while the other conditions are same as the aforesaid Preferred Embodiment I. This comparative example uses the same support members 50 (the visible light transmission of the top part 501 of each support member is 68.1%). No bright spot or dark spot can be seen in this comparative example, but the uniformity of the brightness is dropping with the same arrangement of the CCFL 40. In this comparative example, the brightness uniformity is 62.3% (subject to calculation through the aforesaid Equation I) that measures the 25 determined points of the backlight module.

### Embodiment II

As same as the aforesaid first embodiment, the material of the first diffuser 30 of the direct type backlight module is PET property in this second embodiment, The thickness of the first diffuser is 0.55 mm and a visible light transmission of the first diffuser is 52.3%. The material of the support members 50 is PVC (polyvinyl chloride) property. The visible light transmission of the top part of each support member is 35.2%. The other conditions are the same as the aforesaid first embodiment. The brightness uniformity is 88.3% to determine the 25-point measurement of the backlight module in this second embodiment (subject to calculation through the aforesaid Equation I). Further, no bright spot or dark spot is seen at the contact area between the top part 501 of each support member and the first diffuser 30.

### Comparative Example IV

The direct type backlight module of this comparative example is based on the Embodiment II. This comparative example is simply to change the visible light transmission of the top part 501 of each support member to 5.0% while the other conditions are the same as the aforesaid Embodiment II. This comparative example is to use the first diffuser 30 (having a thickness of 0.55 mm and visible light transmission of 52.3%) as same as the Embodiment II. The result of this combination shows a slight visible dark spot at the contact area between the top part 501 of each support member and the first diffuser 30.

Table I lists the results of the aforesaid embodiments and comparative examples. From these results, we can see that the brightness uniformity of Comparative Example III is drastically reduced because of excessively high visible light transmission of its first diffuser 30. Therefore, the visible light transmission of the first diffuser 30 must be in a proper range to prevent a severe uneven brightness just because of the location arrangement of the CCFLs. Further, the match between the visible light transmission of the top part 501 of each support member and the visible light transmission of the first diffuser 30 is also very important. If they are not matched with each other, the result will have a bright spot or dark spot at the contact surface of the top pail of each support member. In Comparative Example I, the excessively high transmission of the top pail of each support member results in a bright spot. In Comparative Example II, the excessively low transmission of the top part of each support member results in a severe dark spot.

TABLE I

| | | | Transmission (%) | Visible bright | |
|---|---|---|---|---|---|
| | Thickness (mm) | Transmission(%) | of top part of | spot or dark | |
| | of first diffuser | of first diffuser | support member | spot | Uniformity(%) |
| Embodiment I | 0.2 | 56 | 68.1 | Non | 83.5 |
| Comp. Ex. I | 0.2 | 56 | 89.4 | Bright spot | 84.2 |
| Comp Ex. II | 0.2 | 56 | ~0 | Severe dark | 83.9 |
| | | | | spot | |
| Comp. Ex. III | 0.1 | 78.5 | 68.1 | Non | 62.3 |
| Embodiment II | 0.55 | 52.3 | 35.2 | Non | 88.3 |
| Comp. Ex. IV | 0.55 | 52.3 | 5.0 | Slight dark | 88.9 |
| | | | | spot | |

In Comparative Example I, Comparative Example II and Comparative Example III, a relatively thinner first diffuser cannot achieve the desired satisfactory optical results. However, because of harmonic match between the transmission of the first diffuser 30 and transmission of the top part 501 of each support member in Embodiment I and Embodiment II, a relative thicker first diffuser still achieves a satisfactory optical performance. By means of harmonic match between the transmission of the first diffuser 30 and transmission of the top part 501 of each support member, the mass of the diffuser material is greatly reduced and the weight of the backlight module is relatively reduced.

### Embodiment III

Referring to FIG. 4, a direct type backlight module, which accords to the embodiment II, has the same structures and optical elements (the first diffuser 30 has a thickness of 0.55 mm and a visible light transmission of 52.3%, the top part of each support member has a visible light transmission of 5.0%) with the Comparative Example IV. A different thing is to use a second diffuser 33 to put on the top side of the first diffuser 30 (the second diffuser 33 is also prepared from polyethylene terephthalate, and it has a thickness of 0.2 mm and a visible light transmission of 72.3%). The use of the second diffuser 33 eliminates the problem about the slight visible dark spot as the Comparative Example IV.

In the aforesaid embodiments, PET (polyethylene terephthalate) is used for the first diffuser 30. In actual practice, the conventional materials of the first diffuser 30 are such as polycarbonate, polystyrene, methyl methacrylate, styrene-methyl methacrylate, styrene, polyethylene, styrene acrylonitrile, polypropylene, and polyvinyl chloride. Further, in the aforesaid embodiments of the present invention, polyvinyl chloride and polycarbonate are used for making the support members 50. In actual practice, other polymers such as polystyrene, methyl methacrylate, styrene-methyl methacrylate, styrene, polyethylene, polypropylene, polyvinyl chloride, and polyethylene terephthalate may be used for making the support members 50.

Although the present invention has been explained in relation to its preferred embodiments, it is to be understood that many other possible modifications and variations can be made without departing from the spirit and scope of the invention as hereinafter claimed.

What is claimed is:

1. A direct type backlight module comprising:
a housing, said housing comprising a bottom wall and a plurality of sidewalls, said bottom panel and said sidewalls defining an inside space having a top opening;
a reflector mounted on said bottom panel inside said inside space;
a first diffuser mounted on said sidewalls and covering said top opening, said first diffuser having a visible light transmission not greater than 75%;
at least one light source mounted in said inside space; and
a plurality of support members mounted in said inside space to support said first diffuser, said support members each having a top part that supports said first diffuser, said top part having a visible light transmission within 5%˜85%.

2. The direct type backlight module as claimed in claim 1 wherein said first diffuser has a thickness within 0.05 mm˜0.6 mm.

3. The direct type backlight module as claimed in claim 1 wherein the contact area between the top part of each of said support members and said first diffuser is not greater than 1 mm².

4. The direct type backlight module as claimed in claim 3 wherein the contact area between the top part of each of said support members and said first diffuser is a circular area.

5. The direct type backlight module as claimed in claim 3 wherein the contact area between the top part of each of said support members and said first diffuser is an oval area.

6. The direct type backlight nodule as claimed in claim 3 wherein the contact area between the top part of each of said support members and said first diffuser is a rectangular area.

7. The direct type backlight module as claimed in claim 3 wherein the contact area between the top part of each of said support members and said first diffuser is a polygonal area.

8. The direct type backlight module as claimed in claim 1, further comprising a light enhancement film disposed above said first diffuser.

9. The direct type backlight module as claimed in claim 1, further comprising a polarized light enhancement film disposed above said first diffuser.

10. The direct type backlight module as claimed in claim 8, further comprising a second diffuser disposed above said first diffuser.

11. The direct type backlight module as claimed in claim 8, further comprising a polarized light enhancement film disposed above said first diffuser.

12. The direct type backlight module as claimed in claim 11, further comprising a second diffuser disposed above said first diffuser.

13. The direct type backlight module as claimed in claim 8, further comprising a second diffuser disposed above said first diffuser.

14. The direct type backlight module as claimed in claim 9, further comprising a second diffuser disposed above said first diffuser.

15. The direct type backlight module as claimed in claim 1 wherein said first diffuser is prepared from one of the materials including polyethylene terephthalate, polycarbonate, polystyrene, methyl methacrylate, styrene, polyethylene, styrene acrylonitrile, polypropylene, and polyvinyl chloride.

16. The direct type backlight module as claimed in claim 11 wherein said first diffuser is prepared from one of the materials including polyethylene terephthalate, polycarbonate, polystyrene, methyl methacrylate, styrene-methyl methacrylate, styrene, polyethylene, styrene acrylonitrile, polypropylene, and polyvinyl chloride.

17. The direct type backlight module as claimed in claim 1 wherein said support members are prepared from one of the materials including polycarbonate, polystyrene, methyl methacrylate, styrene-methyl methacrylate, styrene, polyethylene, styrene acrylonitrile, polypropylene, and polyvinyl chloride.

18. The direct type backlight module as claimed in claim 1 wherein said support members each further comprises a retaining ring to fasten said at least one light source.

19. The direct type backlight module as claimed in claim 1 wherein said support members are fixedly mounted on said bottom panel.

20. The direct type backlight module as claimed in claim 1 wherein said at least one light source is comprised of at least one cold cathode fluorescent lamp.

21. The direct type backlight module as claimed in claim 1 wherein said at least one light source each is comprised of a hot cathode fluorescent lamp.

22. The direct type backlight nodule as claimed in claim 1 wherein said at least one light source each is comprised of a light emitting diode.
